(19) United States
(12) Patent Application Publication
(10) Pub. No.: US 2026/0262893 A1
(43) Pub. Date: Sep. 10, 2026

(54) MOBILE CLEANING ROBOT WITH ACTUATING GRIPPER

(71) Applicant: iRobot Corporation, Bedford, MA (US)

(72) Inventor: Timothy R. Ohm, Grover Beach, CA (US)

(21) Appl. No.: 19/556,604

(22) Filed: Mar. 4, 2026

Related U.S. Application Data
(60) Provisional application No. 63/768,429, filed on Mar. 7, 2025.

(51) Int. Cl. A47L 11/24; A47L 11/28; A47L 11/40; B25J 9/16; B25J 15/08

(52) U.S. Cl. CPC A47L 11/24; A47L 11/28; A47L 11/4011; B25J 9/1679; B25J 15/08

(57) ABSTRACT

A mobile cleaning robot can include a body and a drive system connected to the body. The drive system can move the body about a floor surface of an environment. The mobile cleaning robot can include an arm assembly connected to the body. The arm assembly can include a linkage assembly pivotably connected to the body, a hand, a linkage actuator, and a hand actuator. The hand can be pivotably connected to the linkage assembly and the hand can include a pair of fingers. The linkage actuator can be connected to the linkage assembly and can move the linkage assembly and the hand relative to the body between a retracted position and an extended position. The hand actuator can be connected to the hand and can be operable to move the fingers between a closed position, an open position, and a stored position.

### CLAIM OF PRIORITY

This patent application claims the benefit of priority, under 35 U.S.C. Section 119(e), to Timothy Ohm, U.S. Provisional Patent Application Serial Number 63/768,429, entitled “MOBILE CLEANING ROBOT WITH ACTUATING GRIPPER,” filed on Mar. 7, 2025, which is hereby incorporated by reference herein in its entirety.

### BACKGROUND

Autonomous mobile robots include autonomous mobile cleaning robots that can autonomously perform cleaning tasks within an environment, such as a home. Many kinds of cleaning robots are autonomous to some degree and in different ways. Some robots can perform vacuuming operations and some can perform mopping operations. Other robots can include components or systems to perform both vacuuming and mopping operations. Most types of mobile cleaning robots can interface with a docking station that can perform maintenance on the robot, such as charging and debris evacuation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a plan view of a mobile cleaning robot in an environment.

FIG. 2A illustrates an isometric view of a mobile cleaning robot in a first condition.

FIG. 2B illustrates an isometric view of a mobile cleaning robot in a second condition.

FIG. 2C illustrates an isometric view of a mobile cleaning robot in a third condition.

FIG. 2D illustrates a bottom view of a mobile cleaning robot in a third condition.

FIG. 2E illustrates a top isometric view of a mobile cleaning robot in a third condition.

FIG. 2F illustrates a side cross-sectional view of a mobile cleaning robot in a first condition.

FIG. 2G illustrates a diagram illustrating an example of a communication network in which a mobile cleaning robot operates and data transmission in the network.

FIG. 3 illustrates an isometric view of a mobile cleaning robot including an arm.

FIG. 4 illustrates an isometric view of a mobile cleaning robot including an arm.

FIG. 5 illustrates an isometric view of a mobile cleaning robot including an arm.

FIG. 6 illustrates an isometric view of a portion of a mobile cleaning robot including an arm.

FIG. 7 illustrates an isometric view of a portion of an arm assembly of a mobile cleaning robot.

FIG. 8 illustrates an isometric view of a portion of an arm assembly of a mobile cleaning robot.

FIG. 9 illustrates a cross-sectional view of a portion of an arm assembly of a mobile cleaning robot.

FIG. 10 illustrates an isometric view of a portion of an arm assembly of a mobile cleaning robot.

FIG. 11 illustrates an isometric cross-sectional view of a portion of an arm assembly of a mobile cleaning robot.

FIG. 12 illustrates an isometric view of a portion of an arm assembly of a mobile cleaning robot.

FIG. 13 illustrates a perspective view of a portion of an arm assembly of a mobile cleaning robot.

FIG. 14 illustrates an isometric view of a mobile cleaning robot including an arm.

### DETAILED DESCRIPTION

Certain mobile cleaning robots can perform vacuuming operations, where a mobile cleaning robot can be deployed, such as from a user interface on a mobile device, or via a schedule, to autonomously clean an environment, including performing vacuum operations in the environment. During cleaning operations, the mobile cleaning robot can encounter obstacles that the mobile cleaning robot can maneuver around during cleaning, such as countertops and chairs. However, the mobile cleaning robot can also encounter obstacles that are not permanent and are not semi-permanent, such as clothing items or toys, which can be referred to as clutter. To clean around clutter items, the robot can detect the items and can navigate around the clutter during cleaning operations. However, these operations can result in relatively inefficient navigation or cleaning patterns and areas underneath the clutter items may not be effectively cleaned.

To help address the problems described above, this disclosure discusses solutions including an arm connected to the robot for picking up clutter and placing the clutter items in a designated area or location that is not in the floor space to be cleaned or vacuumed. Some arms can include several degrees of freedom, such as arms including 4, 5, or 6 degrees of freedom. However, such arms can be relatively complex and expensive. The present application describes a mobile cleaning robot including an arm having only one or two degrees of mechanical freedom, where the robot itself can perform other aspects of navigation required to align the arm with the item to be picked and placed, which can help to reduce complexity and cost of the arm and therefore can help to increase reliability of the arm and the robot.

For example, a mobile cleaning robot can include a body and a drive system connected to the body. The drive system can move the body about a floor surface of an environment. The mobile cleaning robot can include an arm assembly connected to the body. The arm assembly can include a linkage assembly pivotably connected to the body, a hand, a linkage actuator, and a hand actuator. The hand can be pivotably connected to the linkage assembly, and the hand can include a pair of fingers. The linkage actuator can be connected to the linkage assembly and can move the linkage assembly and the hand relative to the body between a retracted position and an extended position. The hand actuator can be connected to the hand and can be operable to move the fingers between a closed position, an open position, and a stored position.

The above discussion is intended to provide an overview of the subject matter of the present patent application. It is not intended to provide an exclusive or exhaustive explanation of the invention. The description below is included to provide further information about the present patent application.

### Robot Operation Summary

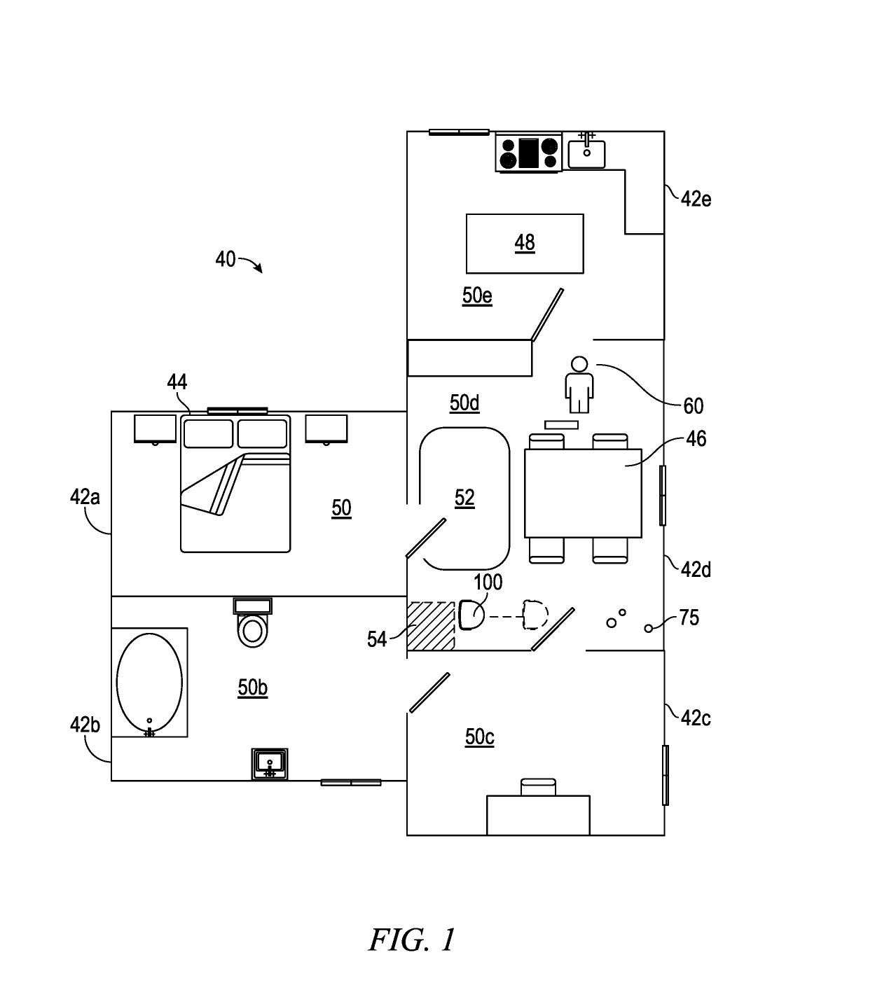

FIG. 1 illustrates a plan view of a mobile cleaning robot 100 in an environment 40, in accordance with at least one example of this disclosure. The environment 40 can be a dwelling, such as a home or an apartment, and can include rooms 42a-42e. Obstacles, such as a bed 44, a table 46, and an island 48 can be located in the rooms 42 of the environment. Each of the rooms 42a-42e can have a floor surface 50a-50e, respectively. Some rooms, such as the room 42d, can include a rug, such as a rug 52. The floor surfaces 50 can be of one or more types, such as hardwood, ceramic, low-pile carpet, medium-pile carpet, long (or high)-pile carpet, stone, or the like.

The mobile cleaning robot 100 can be operated, such as by a user 60, to autonomously clean the environment 40 in a room-by-room fashion. In some examples, the robot 100 can clean the floor surface 50a of one room, such as the room 42a, before moving to the next room, such as the room 42d, to clean the surface of the room 42d. Different rooms can have different types of floor surfaces. For example, the room 42e (which can be a kitchen) can have a hard floor surface, such as wood or ceramic tile, and the room 42a (which can be a bedroom) can have a carpet surface, such as a medium pile carpet. Other rooms, such as the room 42d (which can be a dining room), can include multiple surfaces where the rug 52 is located within the room 42d.

During cleaning or traveling operations, the robot 100 can use data collected from various sensors (such as optical sensors) and calculations (such as odometry and obstacle detection) to develop a map of the environment 40. Once the map is created, the user 60 can define rooms or zones (such as the rooms 42) within the map. The map can be presentable to the user 60 on a user interface, such as a mobile device, where the user 60 can direct or change cleaning preferences, for example.

Also, during operation, the robot 100 can detect surface types within each of the rooms 42, which can be stored in the robot 100 or another device. The robot 100 can update the map (or data related thereto) such as to include or account for surface types of the floor surfaces 50a-50e of each of the respective rooms 42 of the environment 40. In some examples, the map can be updated to show the different surface types such as within each of the rooms 42.

In some examples, the user 60 can define a behavior control zone 54. In autonomous operation, the robot 100 can initiate a behavior in response to being in or near the behavior control zone 54. For example, the user 60 can define an area of the environment 40 that is prone to becoming dirty to be the behavior control zone 54. In response, the robot 100 can initiate a focused cleaning behavior in which the robot 100 performs a focused cleaning of a portion of the floor surface 50d in the behavior control zone 54.

### Robot Example

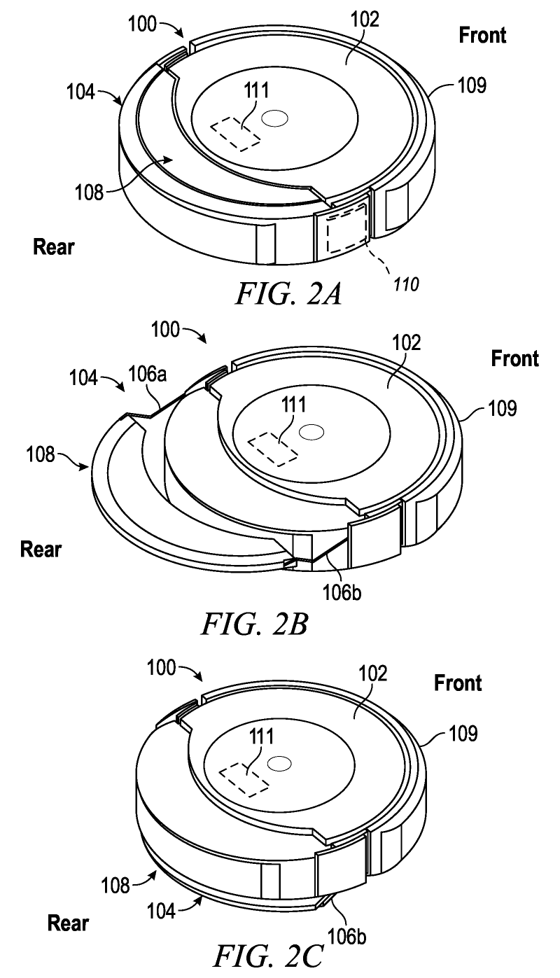

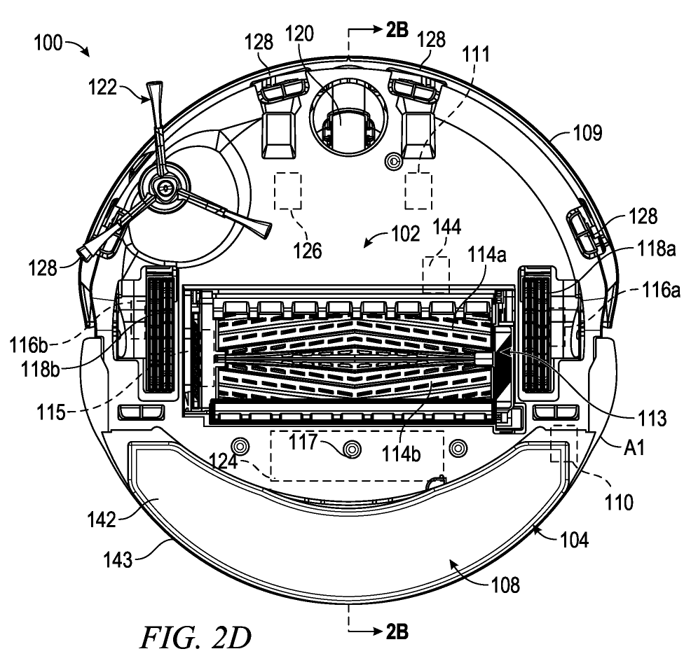

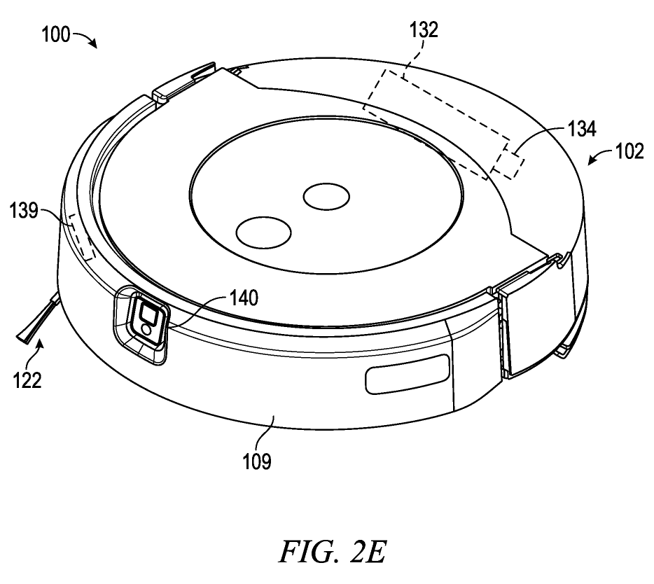

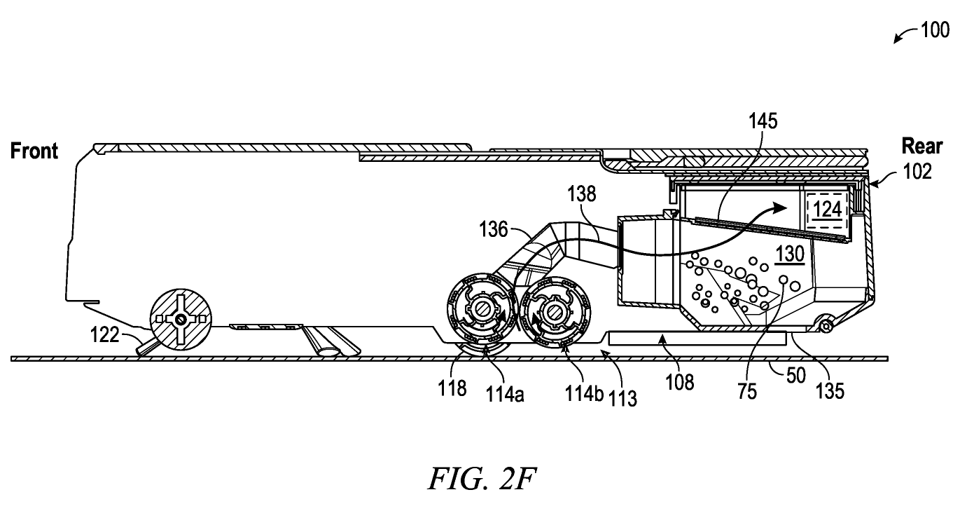

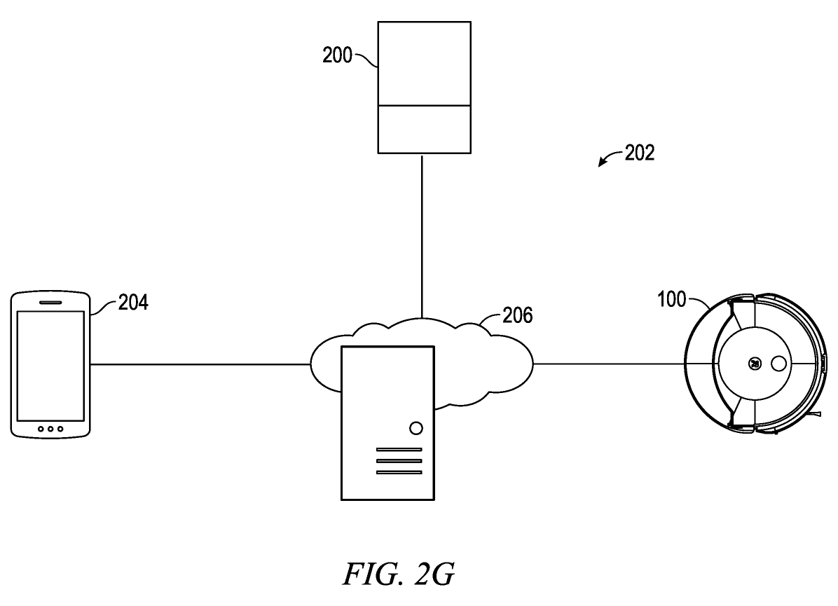

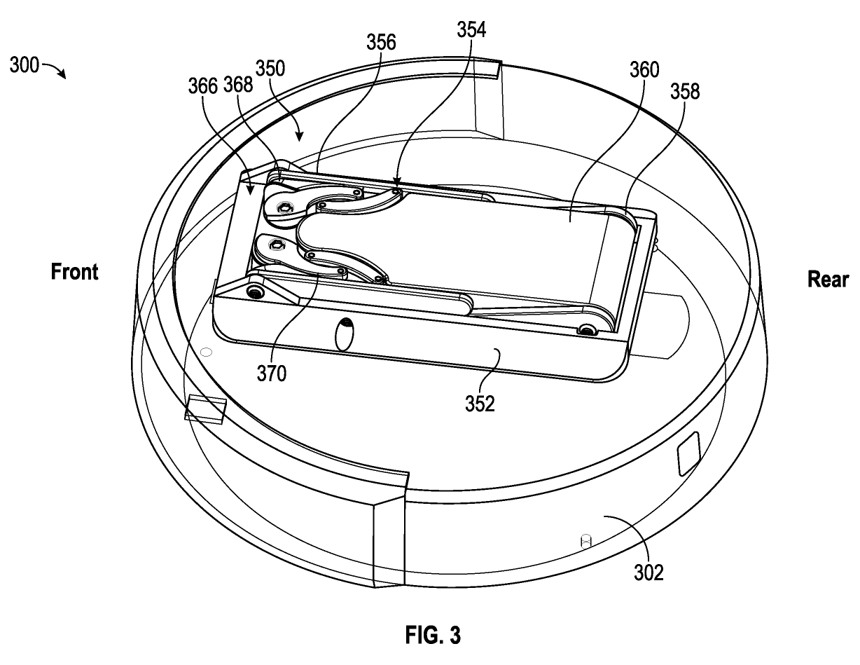

FIG. 2A illustrates an isometric view of a mobile cleaning robot 100 with a pad assembly in a stored position. FIG. 2B illustrates an isometric view of the mobile cleaning robot 100 with the pad assembly in an extended position. FIG. 2C illustrates an isometric view of the mobile cleaning robot 100 with the pad assembly in a mopping position. FIGS. 2A-2C also show orientation indicators Front and Rear. FIGS. 2A-2C are discussed together below.

The mobile cleaning robot 100 can include a body 102 and a mopping system 104. The mopping system 104 can include arms 106a and 106b (referred to together as arms 106) and a pad assembly 108. The robot 100 can also include a bumper 109 and other features such as an extractor (including rollers), one or more side brushes, a vacuum system, a controller, a drive system (e.g., motor, geartrain, and wheels), a caster, and sensors, as discussed in further detail below. A distal portion of the arms 106 can be connected to the pad assembly 108 and a proximal portion of the arms 106a and 106b can be connected to an internal drive system to drive the arms 106 to move the pad assembly 108.

FIGS. 2A-2C show how the robot 100 can be operated to move the pad assembly 108 from a stored position in FIG. 2A to a transition or partially deployed position in FIG. 2B, to a mopping or a deployed position in FIG. 2C. In the stored position of FIG. 2A, the robot 100 can perform only vacuuming operations. In the deployed position of FIG. 2C, the robot 100 can perform vacuuming operations or mopping operations. FIGS. 2D-2E discuss additional components of the robot 100.

### Components of the Robot

FIG. 2D illustrates a bottom view of the mobile cleaning robot 100 and FIG. 2E illustrates a top isometric view of the robot 100. FIGS. 2D and 2E are discussed together below. The robot 100 of FIGS. 2D and 2E can be consistent with FIGS. 2A-2C; FIGS. 2D-2E show additional details of the robot 100. For example, FIGS. 2D-2E show that the robot 100 can include a body 102, a bumper 109, an extractor 113 (including rollers 114a and 114b), motors 116a and 116b, drive wheels 118a and 118b, a caster 120, a side brush assembly 122, a vacuum assembly 124, memory 126, and sensors 128. The mopping system 104 can also include a tank 132 and a pump 134.

The cleaning robot 100 can be an autonomous cleaning robot that can autonomously traverse the floor surface 50 (of FIG. 1) while ingesting debris from different parts of the floor surface 50. As shown in FIG. 2D, the robot 100 can include the body 102 that can be movable across the floor surface 50. The body 102 can include multiple connected structures to which movable or fixed components of the cleaning robot 100 are mounted. The connected structures can include, for example, an outer housing to cover internal components of the cleaning robot 100, a chassis to which the drive wheels 118a and 118b and the cleaning rollers 114a and 114b (of the cleaning assembly 113) are mounted, and the bumper 109 connected to the outer housing. The caster wheel 120 can support the front portion of the body 102 above the floor surface 50, and the drive wheels 118a and 118b can support the middle and rear portions of the body 102 (and can also support a majority of the weight of the robot 100) above the floor surface 50.

As shown in FIG. 2D, the body 102 can include a front portion that can have a substantially semicircular shape and that can be connected to the bumper 109. The body 102 can also include a rear portion that has a substantially semicircular shape. In other examples, the body 102 can have other shapes, such as a square front or straight front. The robot 100 can also include a drive system including the actuators (e.g., motors) 116a and 116b. The actuators 116a and 116b can be connected to the body 102 and can be operably connected to the drive wheels 118a and 118b, which can be rotatably mounted to the body 102. The actuators 116a and 116b, when driven, can rotate the drive wheels 118a and 118b to enable the robot 100 to autonomously move across the floor surface 50.

The vacuum assembly 124 can be located at least partially within the body 102 of the robot 100, such as in a rear portion of the body 102, and the vacuum assembly 124 can be located in other locations in other examples. The vacuum assembly 124 can include a motor to drive an impeller to generate the airflow when rotated. The airflow from the vacuum assembly 124 and the cleaning rollers 114, when rotated, can cooperate to ingest the debris into the robot 100.

The cleaning bin 130 (shown in FIG. 2F) can be mounted in the body 102 and can contain the debris ingested by the robot 100. A filter in the body 102 can separate the debris from the airflow before the airflow enters the vacuum assembly 124 and is exhausted out of the body 102. In this regard, the debris can be captured in both the cleaning bin 130 and the filter before the airflow is exhausted from the body 102. In some examples, the vacuum assembly 124 and extractor 113 can be optionally included or can be of a different type. Optionally, the vacuum assembly 124 can be operated during mopping operations, such as those including the mopping system 104. That is, the robot 100 can perform simultaneous vacuuming and mopping missions or operations.

The cleaning rollers 114a and 114b can be operably connected to an actuator 115, e.g., a motor, through a gearbox. The cleaning head 113 and the cleaning rollers 114a and 114b can be located forward of the cleaning bin 130. The cleaning rollers 114 can be mounted or connected to an underside of the body 102 so that the cleaning rollers 114a and 114b can engage debris on the floor surface 50 during the cleaning operation when the underside of the body 102 faces the floor surface 50.

The controller 111 can be located at least partially within the housing 102 and can be a programmable controller, such as a single or multi-board computer, a direct digital controller (DDC), a programmable logic controller (PLC), or the like. In other examples, the controller 111 can be any computing device, such as a handheld computer, for example, a smartphone, a tablet, a laptop, a desktop computer, or any other computing device including a processor, memory, and communication capabilities. The memory 126 can be one or more types of memory, such as volatile or non-volatile memory, read-only memory (ROM), random-access memory (RAM), magnetic disk storage media, optical storage media, flash-memory devices, and other storage devices and media. The memory 126 can be located within the housing 102, can be connected to the controller 111, and can be accessible by the controller 111.

The controller 111 can operate the actuators 116a and 116b to autonomously navigate the robot 100 about the floor surface 50 during a cleaning operation. The actuators 116a and 116b can be operable to drive the robot 100 in a forward drive direction, in a backward direction, and to turn the robot 100. The controller 111 can operate the vacuum assembly 124 to generate an airflow that flows through an air gap near the cleaning rollers 114, through the body 102, and out of the body 102.

The robot 100 can include a sensor system including one or more sensors. The sensor system, as described herein, can generate one or more signals indicative of a current location of the robot 100, and can generate signals indicative of locations of the robot 100 as the robot 100 travels along the floor surface 50. The sensors 128 (shown in FIG. 2A) can be located along a bottom portion of the housing 102. Each of the sensors 128 can be an optical sensor that can be configured to detect a presence or absence of an object below the optical sensor, such as the floor surface 50. The sensors 128 (optionally cliff sensors) can be connected to the controller 111 and can be used by the controller 111 to navigate the robot 100 within the environment 40. In some examples, the cliff sensors can be used to detect a floor surface type which the controller 111 can use to selectively operate the mopping system 104.

The cleaning pad assembly 108 can be a cleaning pad connected to the bottom portion of the body 102 (or connected to the actuator 110 that can be configured to move the assembly 108 between a stored position and a cleaning position), such as to the cleaning bin 130 in a location to the rear of the extractor 113. The tank 132 can be a water tank configured to store water or fluid, such as cleaning fluid, for delivery to a mopping pad 142. The pump 134 can be connected to the controller 111 and can be in fluid communication with the tank 132. The controller 111 can be configured to operate the pump 134 to deliver fluid to the mopping pad 142 during mopping operations. For example, fluid can be delivered through one or more dispensers 117 to the mopping pad 142. The dispenser(s) 117 can be a valve, opening, or the like and can be configured to deliver fluid to the floor surface 50 of the environment 40 or to the pad 142 directly. In some examples, the pad 142 can be a dry pad such as for dusting or dry debris removal. The pad 142 can be supported by a pad tray 143 connected to the arm 106. The mopping pad 142 can also be any cloth, fabric, or the like configured for cleaning (either wet or dry) of a floor surface.

As shown in FIG. 2F, the vacuum assembly 124 can be located at least partially within the body 102 of the robot 100, e.g., in the rear portion of the body 102. The controller 111 can operate the vacuum assembly 124 to generate an airflow that flows through the air gap near the cleaning rollers 114, through the body 102, and out of the body 102. The airflow and the cleaning rollers 114, when rotated, can cooperate to ingest debris 75 into a suction duct 136 of the robot 100. The suction duct 136 can extend down to or near a bottom portion of the body 102 and can be at least partially defined by the cleaning assembly 113.

The suction duct 136 can be connected to the cleaning head 113 or cleaning assembly and can be connected to a cleaning bin 130. The cleaning bin 130 can be mounted in the body 102 and can contain the debris 75 ingested by the robot 100. A filter 145 can be located in the body 102, which can help to separate the debris 75 from the airflow before the airflow 138 enters the vacuum assembly 124 and is exhausted out of the body 102. In this regard, the debris 75 can be captured in both the cleaning bin 130 and the filter before the airflow 138 is exhausted from the body 102. The robot 100 can also include a debris port 135 that can extend at least partially through the body 102 or the cleaning bin 130 and can be operable to remove the debris 75 from the cleaning bin 130, such as via a docking station or evacuation station.

The cleaning rollers 114a and 114b can be operably connected to one or more actuators 115, e.g., motors, respectively. The cleaning head 113 and the cleaning rollers 114a and 114b can be positioned forward of the cleaning bin 130. The cleaning rollers 114a and 114b can be mounted to a housing of the cleaning head 113 and mounted, e.g., indirectly or directly, to the body 102 of the robot 100. In particular, the cleaning rollers 114a and 114b can be mounted to an underside of the body 102 so that the cleaning rollers 114a and 114b engage debris 75 on the floor surface 50 during the cleaning operation when the underside faces the floor surface 50.

### Operation of the Robot

In operation of some examples, the controller 111 can be used to instruct the robot 100 to perform a mission. In such a case, the controller 111 can operate the motors 116 to drive the drive wheels 118 and propel the robot 100 along the floor surface 50. The robot 100 can be propelled in a forward drive direction or a rearward drive direction. The robot 100 can also be propelled such that the robot 100 turns in place or turns while moving in the forward drive direction or the rearward drive direction. In addition, the controller 111 can operate the motors 115 to cause the rollers 114a and 114b to rotate, can operate the side brush assembly 122, and can operate the motor of the vacuum system 124 to generate airflow. The controller 111 can execute software stored on the memory 126 to cause the robot 100 to perform various navigational and cleaning behaviors by operating the various motors of the robot 100.

The various sensors of the robot 100 can be used to help the robot navigate and clean within the environment 40. For example, the cliff sensors can detect obstacles such as drop-offs and cliffs below portions of the robot 100 where the cliff sensors are disposed. The cliff sensors can transmit signals to the controller 111 so that the controller 111 can redirect the robot 100 based on signals from the sensors.

Proximity sensors can produce a signal based on a presence or the absence of an object in front of the optical sensor. For example, detectable objects include obstacles such as furniture, walls, persons, and other objects in the environment 40 of the robot 100. The proximity sensors can transmit signals to the controller 111 so that the controller 111 can redirect the robot 100 based on signals from the proximity sensors. In some examples, a bump sensor can be used to detect movement of the bumper 109 along a fore-aft axis of the robot 100. A bump sensor 139 can also be used to detect movement of the bumper 109 along one or more sides of the robot 100 and can optionally detect vertical bumper movement. The bump sensors 139 can transmit signals to the controller 111 so that the controller 111 can redirect the robot 100 based on signals from the bump sensors 139.

The robot 100 can also optionally include one or more dirt sensors 144 connected to the body 102 and in communication with the controller 111. The dirt sensors 144 can be a microphone, piezoelectric sensor, optical sensor, or the like located in or near a flow path of debris, such as near an opening of the cleaning rollers 114 or in one or more ducts within the body 102. This can allow the dirt sensor(s) 144 to detect how much dirt is being ingested by the vacuum assembly 124 (e.g., via the extractor 113) at any time during a cleaning mission. Because the robot 100 can be aware of its location, the robot 100 can keep a log or record of which areas or rooms of the map are dirtier or where more dirt is collected.

The image capture device 140 can be configured to generate a signal based on imagery of the environment 40 of the robot 100 as the robot 100 moves about the floor surface 50. The image capture device 140 can transmit such a signal to the controller 111. The controller 111 can use the signal or signals from the image capture device 140 for various tasks, algorithms, or the like, as discussed in further detail below.

In some examples, the obstacle following sensors can detect detectable objects, including obstacles such as furniture, walls, persons, and other objects in the environment of the robot 100. In some implementations, the sensor system can include an obstacle following sensor along the side surface, and the obstacle following sensor can detect the presence or absence of an object adjacent to the side surface. The one or more obstacle following sensors can also serve as obstacle detection sensors, similar to the proximity sensors described herein.

The robot 100 can also include sensors for tracking a distance travelled by the robot 100. For example, the sensor system can include encoders associated with the motors 116 for the drive wheels 118, and the encoders can track a distance that the robot 100 has travelled. In some implementations, the sensor can include an optical sensor facing downward toward a floor surface. The optical sensor can be positioned to direct light through a bottom surface of the robot 100 toward the floor surface 50. The optical sensor can detect reflections of the light and can detect a distance travelled by the robot 100 based on changes in floor features as the robot 100 travels along the floor surface 50.

The controller 111 can use data collected by the sensors of the sensor system to control navigational behaviors of the robot 100 during the mission. For example, the controller 111 can use the sensor data collected by obstacle detection sensors of the robot 100, (the cliff sensors, the proximity sensors, and the bump sensors) to enable the robot 100 to avoid obstacles within the environment of the robot 100 during the mission.

The sensor data can also be used by the controller 111 for simultaneous localization and mapping (SLAM) techniques in which the controller 111 extracts features of the environment represented by the sensor data and constructs a map of the floor surface 50 of the environment. The sensor data collected by the image capture device 140 can be used for techniques such as vision-based SLAM (VSLAM) in which the controller 111 extracts visual features corresponding to objects in the environment 40 and constructs the map using these visual features. As the controller 111 directs the robot 100 about the floor surface 50 during the mission, the controller 111 can use SLAM techniques to determine a location of the robot 100 within the map by detecting features represented in collected sensor data and comparing the features to previously stored features. The map formed from the sensor data can indicate locations of traversable and nontraversable space within the environment. For example, locations of obstacles can be indicated on the map as nontraversable space, and locations of open floor space can be indicated on the map as traversable space.

The sensor data collected by any of the sensors can be stored in the memory 126. In addition, other data generated for the SLAM techniques, including mapping data forming the map, can be stored in the memory 126. These data produced during the mission can include persistent data that are produced during the mission and that are usable during further missions. In addition to storing the software for causing the robot 100 to perform its behaviors, the memory 126 can store data resulting from processing of the sensor data for access by the controller 111. For example, the map can be a map that is usable and updateable by the controller 111 of the robot 100 from one mission to another mission to navigate the robot 100 about the floor surface 50.

The persistent data, including the persistent map, can help to enable the robot 100 to efficiently clean the floor surface 50. For example, the map can enable the controller 111 to direct the robot 100 toward open floor space and to avoid nontraversable space. In addition, for subsequent missions, the controller 111 can use the map to optimize paths taken during the missions to help plan navigation of the robot 100 through the environment 40.

The controller 111 can also send commands to a motor or actuator 110 (shown in FIG. 2A) that can be connected to the arms 106 and can be located at least partially within the body 102, where the command(s) can drive the arms 106 to move the pad assembly 108 between the stored position (shown in FIGS. 2A and 2D) and the deployed position (shown in FIGS. 2C and 2E). In the deployed position, the pad assembly 108 (the mopping pad 142) can be used to mop a floor surface of any room of the environment 40.

The mopping pad 142 can be a dry pad or a wet pad. Optionally, when the mopping pad 142 is a wet pad, the pump 134 can be operated by the controller 111 to spray or drop fluid (e.g., water or a cleaning solution) onto the floor surface 50 or the mopping pad 142. The wetted mopping pad 142 can then be used by the robot 100 to perform wet mopping operations on the floor surface 50 of the environment 40.

### Network Examples

FIG. 2G is a diagram showing a communication network 202 that enables networking between the mobile robot 100 and one or more other devices, a docking station 200 (or any of the docking stations discussed herein), a mobile device 204 (including a controller), a cloud computing system 206 (including a controller), or another autonomous robot separate from the mobile robot 100. Using the communication network 202, the robot 100, the mobile device 204, the docking station 200, and the cloud computing system 206 can communicate with one another to transmit and receive data from one another. In some examples, the robot 100, the docking station 200, or both the robot 100 and the docking station 200 can communicate with the mobile device 204 through the cloud computing system 206. Alternatively, or additionally, the robot 100, the docking station 200, or both the robot 100 and the docking station 200 can communicate directly with the mobile device 204. Various types and combinations of wireless networks (e.g., Bluetooth, radio frequency, optical-based, etc.) and network architectures (e.g., wi-fi or mesh networks) can be employed by the communication network 202.

In some examples, the mobile device 204 can be a remote device that can be linked to the cloud computing system 206 and can enable a user to provide inputs. The mobile device 204 can include user input elements such as, for example, one or more of a touchscreen display, buttons, a microphone, a mouse, a keyboard, or other devices that respond to inputs provided by the user. The mobile device 204 can also include immersive media (e.g., virtual reality or augmented reality) with which the user can interact to provide input. The mobile device 204, in these examples, can be a virtual reality headset or a head-mounted display.

The user can provide inputs corresponding to commands for the mobile robot 100. In such cases, the mobile device 204 can transmit a signal to the cloud computing system 206 to cause the cloud computing system 206 to transmit a command signal to the mobile robot 100. In some implementations, the mobile device 204 can present augmented reality images. In some implementations, the mobile device 204 can be a smart phone, a laptop computer, a tablet computing device, or other mobile device.

In some examples, the communication network 202 can include additional nodes. For example, nodes of the communication network 202 can include additional robots. Also, nodes of the communication network 202 can include network-connected devices that can generate information about the environment 40. Such a network-connected device can include one or more sensors, such as an acoustic sensor, an image capture system, or other sensor generating signals, to detect characteristics of the environment 40 from which features can be extracted. Network-connected devices can also include home cameras, smart sensors, or the like. In the communication network 202, the wireless links can utilize various communication schemes, protocols, etc., such as, for example, Bluetooth classes, Wi-Fi, Bluetooth-low-energy, also known as BLE, 802.15.4, Worldwide Interoperability for Microwave Access (WiMAX), an infrared channel, satellite band, or the like. In some examples, wireless links can include any cellular network standards used to communicate among mobile devices, including, but not limited to, standards that qualify as 1G, 2G, 3G, 4G, 5G, or the like. The network standards, if utilized, qualify as, for example, one or more generations of mobile telecommunication standards by fulfilling a specification or standards such as the specifications maintained by the International Telecommunication Union. For example, the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods, e.g., FDMA, TDMA, CDMA, or SDMA.

### Robot and Arm Examples

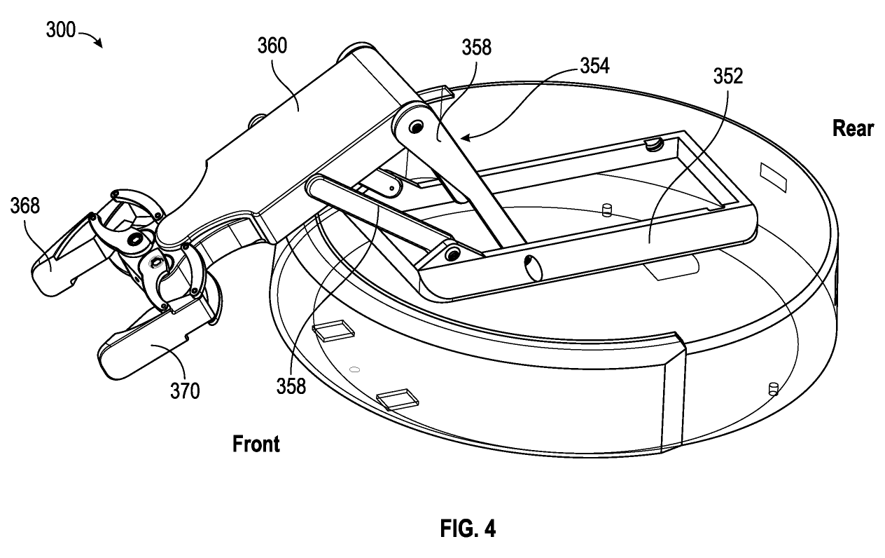

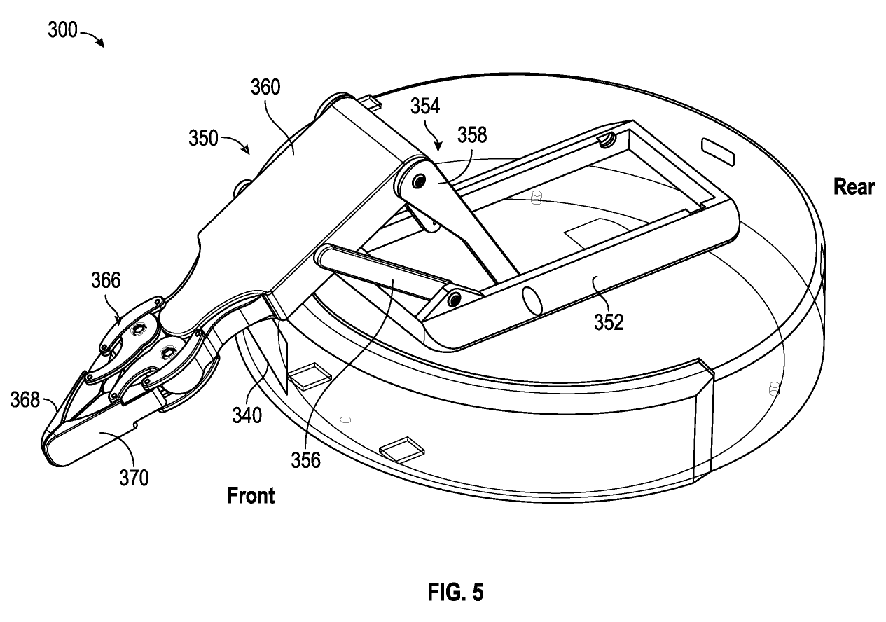

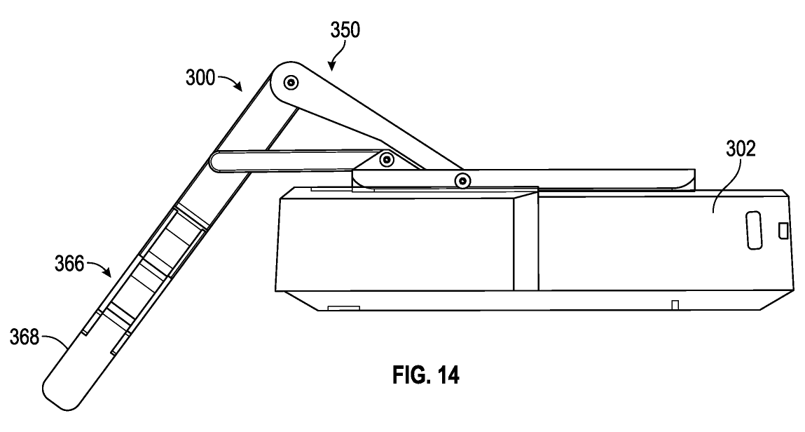

FIG. 3 illustrates an isometric view of a mobile cleaning robot 300 including an arm assembly 350. FIG. 4 illustrates an isometric view of the mobile cleaning robot 300 including the arm assembly 350. FIG. 5 illustrates an isometric view of the mobile cleaning robot 300 including the arm assembly 350. FIG. 3 shows the arm 350 in a stored position or configuration; FIG. 4 shows the arm assembly 350 in a deployed or extended position or configuration; and FIG. 5 shows the arm assembly 350 with a hand in an extended or opened configuration. FIGS. 3-5 are discussed together below. FIG. 14 also shows the arm assembly 350 in a fully extended position, such that the arm assembly 350 can extend to or beyond a flooring surface.

The mobile cleaning robot 300 can be similar to the robot 100 discussed above in that the mobile cleaning robot 300 can include a body 302, a drive train (including wheels and actuators), an extractor, a mopping system (optionally), a controller (e.g., the controller 111), and the like. The mobile cleaning robot 300 can also include the arm assembly 350, which can include a frame 352 connected to the body 302 and configured to support the arm assembly 350 from the body 302. The frame 352 can be a rigid or semi-rigid body that can be fastened to the body 302 (e.g., using one or more of fasteners and adhesives), can be integrally formed into the body 302, or the like. The frame 352 can be optionally releasably securable to the body 302, such as via a magnetic interface (e.g., one or more magnets connected to the frame 352 or the body 302). Any of the components of the arm assembly 350 can be made of materials such as one or more of metals, plastics, foams, elastomers, ceramics, composites, or the like.

The arm assembly 350 can also include a linkage assembly 354 including a pair of front links 356 and a pair of rear links 358. The front links 356 and rear links 358 can be pivotably connected to the frame 352 and to a body 360 of the arm assembly 350. Optionally, the front links 356 and the rear links 358 can include or can form a four bar linkage. The links 356 and 358 can be relatively flat and elongate members, allowing the front links 356 and the rear links 358 to fold into the frame 352 for relatively compact storage.

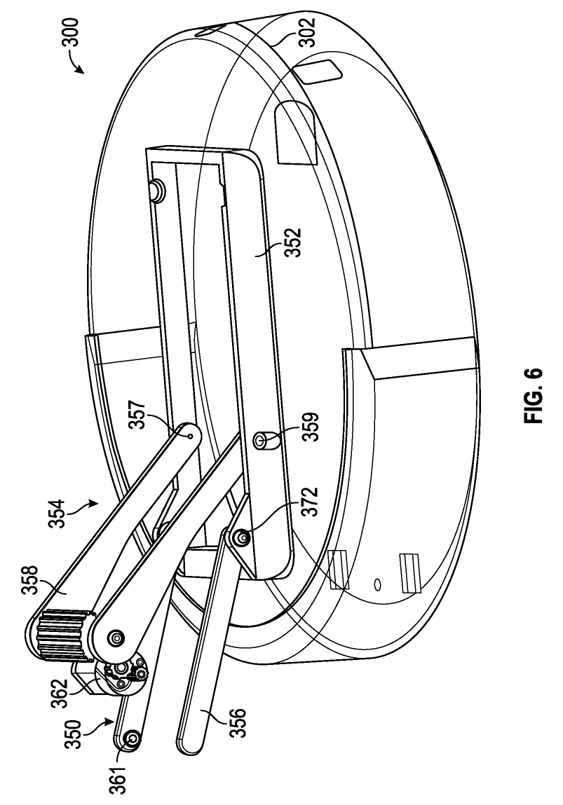

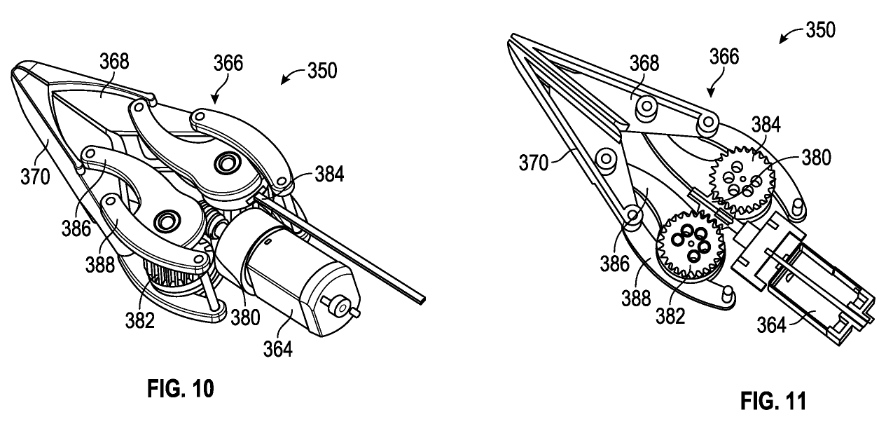

The body 360 can be configured to at least partially enclose a linkage actuator 362 (shown in FIG. 6 below) and a hand actuator 364 (shown in FIG. 10 below). Each of the linkage actuator 362 and the hand actuator 364 can be an electromechanical actuator configured to generate movement, such as rotation or translation via an output shaft or gear. The body 360 can also enclose one or more battery cells configured to provide power to the linkage actuator 362 and the hand actuator 364 such that the arm assembly 350 does not need to connect to the mobile cleaning robot 300 via wire. In such an example, the arm assembly 350 can be wirelessly connected to the controller 111, such as via Bluetooth, Wi-Fi, NFC, or the like.

The arm assembly 350 can also include a hand 366 pivotably connected to the linkage assembly 354, such as via the body 360. The hand 366 can include a pair of fingers 368 and 370 that can be movable between a retracted position (shown in FIG. 3), an open position (shown in FIG. 4), and a closed position (shown in FIG. 5). As shown in FIGS. 4 and 5, the pair of fingers 368 and 370 can be configured to move in parallel through at least a portion of the range of motion therebetween, which can improve dexterity, grasp-ability, and control of the pair of fingers 368 and 370.

As shown in FIG. 3, the linkage assembly 354, the hand 366, and the body 360 (including the linkage actuator 362 and the hand actuator 364) can be configured to nest within the frame 352 when the linkage assembly 354 is in the retracted position. In such a position, extension of these components above the frame can be limited. Optionally, the linkage assembly 354, the hand 366, and the body 360 (including the linkage actuator 362 and the hand actuator 364) can nest entirely within the frame 352 such that nothing extends vertically beyond the frame 352 when the arm assembly 350 is nested or stored. Optionally, the frame 352 can be recessed at least partially into the body 302 such that the arm assembly 350 can nest entirely within the frame 352 and the body 302 such that nothing extends vertically beyond the body 302 (or a top plate or cover thereof) when the arm assembly 350 is nested or stored.

FIG. 5 shows that the hand 366 can be movable to extend in front of a camera 340 of the mobile cleaning robot 300, where the camera 340 can be similar to or the same as the image capture device 140. Such an arrangement can help to allow a controller (e.g., the controller 111) to operate the arm assembly 350 to grasp items. In operation of some examples, the controller 111 can be configured to communicate with the linkage actuator 362, the hand actuator 364, and an encoder connected to one or more of the front links 356 or the rear links 358. The controller 111 can control the linkage actuator and the hand actuator based on the signal.

In operation of some examples, the controller 111 can detect an object on the floor surface and can control the motors 116 to move the drive wheels 118 to navigate the body 302 of the mobile cleaning robot 300 so that the hand 366 will align with the object when the hand 366 is in the extended position. For example, the controller 111 can estimate an extended position of the hand 366 before the hand 366 is extended.

The controller 111 can then operate the linkage actuator 362 to move the arm assembly 350 to the extended position. The controller 111 can then operate the hand actuator 364 to move the fingers 368 and 370 from the stored position to the open position, as shown in FIG. 4. The controller 111 can then operate the hand actuator 364 to move the fingers from the open position to the closed position to engage and grasp the object with the fingers 368 and 370. The controller 111 can then operate the linkage actuator 362 to move the arm assembly 350 to lift the object off the floor surface. The controller 111 can operate the drive system (e.g., the motors 116 and the drive wheels 118) to move the body 302 to a designated place location. And, the controller 111 can operate the hand actuator 364 to open the fingers 368 and 370 to drop or place the object in the designated place location. Such a process can be repeated as needed to clear clutter or items from the environment such as before, during, or after one or more cleaning missions.

The controller 111 can also operate the mobile cleaning robot 300 to open doors when the doors of an environment are blocking a path of the mobile cleaning robot 300 during a cleaning operation. For example, the controller 111 can also operate the drive system (e.g., the motors 116 and the drive wheels 118) to move the body 302 into a position where the arm assembly 350 can be extended or operated to engage the door. The controller 111 can then operate the arm assembly 350 to extend the body 360 and the hand 366 to engage the door. In some examples, the controller 111 can operate the hand actuator 364 to close the fingers 368 and 370 to create or form a spear or pointed hand, and the controller 111 can extend the body 360 and the fingers 368 and 370 between the door and its frame to pry the door ajar (or further open). The controller 111 can then operate the drive system to drive the door further open to allow the mobile cleaning robot 300 to enter a different room or space in the environment. In some examples, the controller 111 can operate the fingers 368 and 370 to grasp a portion of the door or handle to move the door. In some examples, the controller 111 can operate the mobile cleaning robot 300 to rotate or pivot to rotate the door open.

In this way, the mobile cleaning robot 300 can include an arm assembly 350 having only one or two degrees of mechanical freedom, where the robot itself can perform other aspects of navigation required to align the arm with the item to be engaged or picked and placed, which can help to reduce complexity and cost of the arm assembly 350 and therefore can help to increase reliability of the arm assembly 350 and the robot 300.

FIG. 6 illustrates an isometric view of a portion of the mobile cleaning robot 300. The mobile cleaning robot 300 can be consistent with FIGS. 3-5 discussed above. FIG. 6 shows the arm assembly 350 with the body 360 removed to more clearly show that the linkage assembly 354 can include two pairs of links 356 and 358. Each of the links can include a bore or opening 357 that can be configured to receive one or more fasteners 359 therein or therethrough, where the opening 357 and the one or more fasteners 359 can be used to secure the front links 356 or the rear links 358 to the frame 352 and can also function as bearings for movement of the front links 356 and the rear links 358 with respect to the frame 352. The front links 356 can also include bosses 361 that can extend inwardly from bodies of the links (e.g., towards each other) and can be configured to be secured to the body 360, such as to connect the rear links 358 to the body 360 and to form a bearing between the body 360 and the rear links 358.

FIG. 6 also shows that the arm assembly 350 can include an encoder 372 that can be connected to one of the front links 356 and can be connected to the frame 352. The encoder 372 can be in communication with the controller 111, and the encoder 372 can be configured to generate a signal based on a position of the front links 356 with respect to the frame 352 or relative to the body 302. The controller 111 can use the signal to determine a position of the linkage assembly 354. The encoder 372 can be an absolute encoder, which can help to more precisely determine a position of the linkage assembly 354 and the arm assembly 350 generally. Because the linkage assembly 354 can be configured to move over a predetermined arc, the controller 111 can determine a precise location of the arm assembly 350 based on the signal from the encoder 372. The encoder 372 can also help to determine a position of the linkage assembly 354 after a clutch (376 in FIG. 7 below) disengages the linkage actuator 362 from the linkage assembly 354.

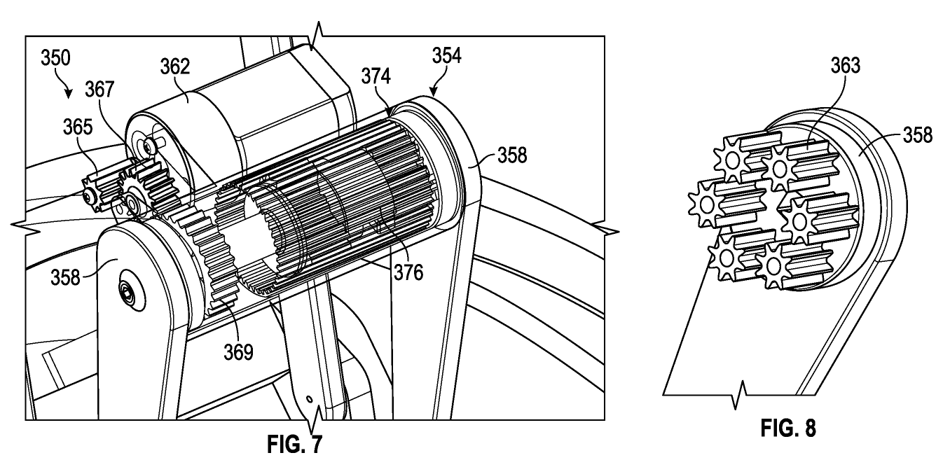

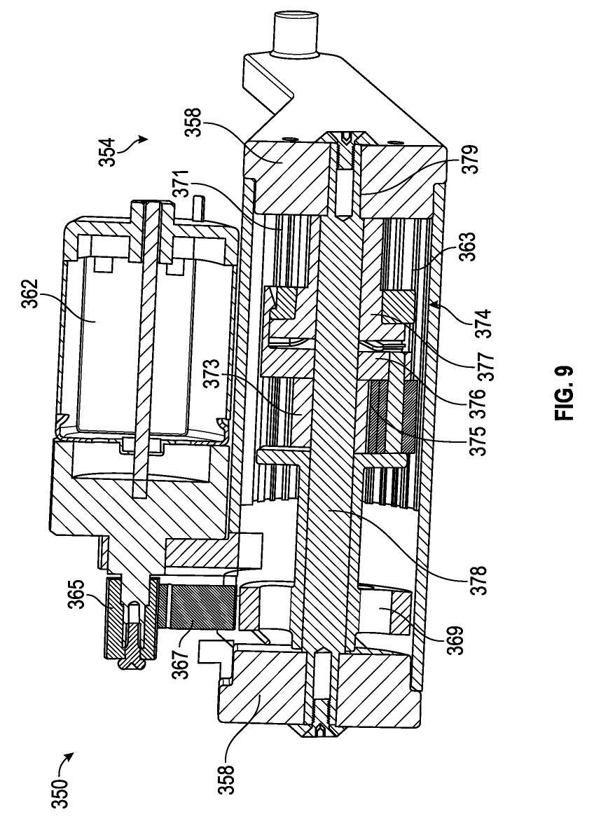

FIG. 7 illustrates an isometric view of a portion of the arm assembly 350 of the mobile cleaning robot 300. FIG. 8 illustrates an isometric view of a portion of the arm assembly 350 of the mobile cleaning robot 300. FIG. 9 illustrates a cross-sectional view of a portion of the arm assembly 350 of the mobile cleaning robot 300. FIGS. 7-9 are discussed together below and show that the arm assembly 350 can include a linkage drive train 374 that can be connected to the linkage assembly 354 (e.g., via the rear links 358) and can be connected to the linkage actuator 362, such as via one or more gears. The gears can be bevel gears, spur gears, worm gears, or the like. The linkage drive train 374 can be configured to transfer power from the linkage actuator 362 to the linkage assembly to move the linkage assembly between the retracted position and the extended position.

FIGS. 7 and 9 also show that the arm assembly 350 can include a clutch 376 connected to the linkage drive train 374 that can be configured to disengage the linkage assembly 354 from the linkage actuator 362 when a force applied to the linkage assembly 354 exceeds a threshold force. The clutch 376 can be biased to reconnect the linkage assembly 354 to the linkage actuator 362 when the force exceeding the threshold is reduced below the threshold. FIGS. 7 and 9 also show that the rear links 358 can be connected by a shaft 378 that can extend through the linkage drive train 374 and the clutch 376 to help ensure that the rear links 358 move together when the linkage drive train 374 drives the right rear link 358 to move. The shaft 378 can be connected to or extend through bores 379 of the rear links 358. The bores 379 can be square or non-circular, such as to ensure the shaft 378 transfers motion between the rear links 358 and limits relative rotation of the shaft 378 with respect to the rear links 358. The shaft 378 can include square or non-circular end links that can engage with the bores 379 to ensure such operation.

FIGS. 8 and 9 show that the rear links 358 can be connected to a planetary gear system including gears 363 that can be driven by the linkage actuator 362 to drive the rear links 358 to rotate or pivot. The gears 363 can include 1, 2, 3, 4, 5, 6, 7, 8, 9, 10 gears or the like, such that the gears 363 can be configured to transfer a desired torque to a housing 371 that can include internal splines or teeth. The housing 371 can be connected to the rear links 358 to transfer the rotational force therebetween.

As shown in FIGS. 7 and 9, the linkage actuator 362 can be connected to a drive gear 365, which can interface with an idler gear 367 that connects to a driven link gear 369 such that the driven link gear 369 can be driven to rotate by the drive gear 365. The driven link gear 369 can be supported by the shaft 378 such that the driven link gear 369 rotates about the shaft 378. The shaft 378 can include an elongate portion connected to a gear 373 that interfaces with planetary gears 375 of the clutch 376. A second side of the clutch 376 can include a gear 377 that interfaces with the gears 363. When the clutch 376 is connected, power can be transferred from the drive gear 365, through the clutch 376 and to the gears 363 to transfer power to the housing 371 and therefore to the rear links 358. However, when a breakaway force or torque is reached, the clutch 376 can disengage and limit transfer from the gear 373 to the gears 363 and limit or prevent damage to the linkage actuator 362 and the linkage drive train 374. The clutch 376 can be located as a second stage from the end to help balance overload protection load applied to the clutch 376 while reducing an amount of torque or load needed to be handled by the clutch 376 by moving one or two stages away from the final stage.

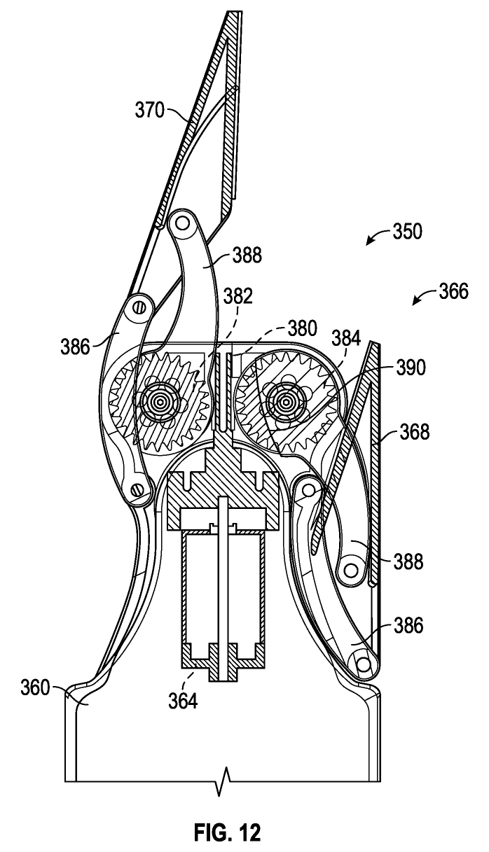

FIG. 10 illustrates an isometric view of a portion of the arm assembly 350. FIG. 11 illustrates an isometric cross-sectional view of a portion of the arm assembly 350. FIG. 12 illustrates an isometric view of a portion of the arm assembly 350. FIGS. 10-12 are discussed together below. The mobile cleaning robot 300 and the arm assembly 350 of FIGS. 10-12 can be consistent with FIGS. 3-9 above; FIGS. 10-12 show additional details of the hand 366.

For example, FIGS. 10-12 show a drive worm 380 connected to the hand actuator 364 and supported by the body 360. FIGS. 10-12 also show that the hand actuator 364 can be located at least partially within the body 360. The hand 366 can also include a pair of worm gears 382 and 384 connected respectively to the pair of fingers 368 and 370. The drive worm 380 can be engaged with the pair of worm gears 382 and 384 such that the hand actuator 364 can be operable to drive the drive worm 380 to move the fingers 368 and 370 between the closed position, the open position, and the stored position.

FIGS. 10-12 also show that the hand 366 can include outer links 386 and inner links 388. The inner links 388 can be connected to the worm gears 382 and 384 and can be pivotably connected to the respective fingers 368 and 370. The outer links 386 can be pivotably coupled to the body 360 and to the fingers 368 and 370. Each outer link 386 and inner link 388 pair can form a linkage for each finger 368 to allow the fingers 368 and 370 to move between the stored position (as shown by the finger 368 in FIG. 12) and the extended position (as shown by the finger 370 in FIG. 12). The inner links 388 can include a recess, cut, or the like 390, allowing the outer links 386 and the inner links 388 to operate over a large range of motion, such as 120 degrees to 170 degrees. The fingers can also include cuts, recesses, scallops, or the like, configured to allow the outer links 386, inner links 388, and fingers to nest within the arm assembly 350 in the stored configuration.

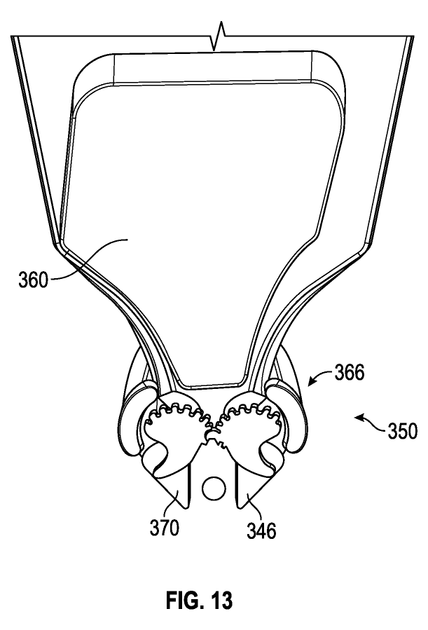

FIG. 13 illustrates a perspective view of a portion of the arm assembly 350 of the mobile cleaning robot 300. The perspective shown in FIG. 13 can be that of a camera of the mobile cleaning robot 300, such as the image capture device 140. The arm assembly 350 can be secured to the body 302 in such a way that the fingers 368 and 370 extend directly in front of the image capture device to allow the image capture device to capture images of movement of the arm assembly 350 (e.g., the hand 366) and objects with which the hand 366 will interact or does interact. This can help to simplify operation or programming related to control of the arm assembly 350 in use.

FIG. 14 illustrates an isometric view of the mobile cleaning robot 300, including the arm 350. The mobile cleaning robot 300 of FIG. 14 can be consistent with the mobile cleaning robot 300 discussed above. FIG. 14 shows that the arm assembly 350 can have a range of motion that can allow the fingers 368 of the hand 366 to extend significantly below a bottom surface or drive wheels of the body 302 of the mobile cleaning robot 300. This can allow the arm assembly 350 to be used to grasp items below the mobile cleaning robot 300, such as past a threshold or step of an environment.

### NOTES AND EXAMPLES

The following, non-limiting examples, detail certain aspects of the present subject matter to solve the challenges and provide the benefits discussed herein, among others.

Example 1 is a mobile cleaning robot comprising: a body; a drive system connected to the body and configured to move the body about a floor surface of an environment; and an arm assembly connected to the body, the arm assembly comprising: a linkage assembly pivotably connected to the body; a hand pivotably connected to the linkage assembly, the hand including a pair of fingers; a linkage actuator connected to the linkage assembly and operable to move the linkage assembly and the hand relative to the body between a retracted position and an extended position; and a hand actuator connected to the hand and operable to move the fingers between a closed position, an open position, and a stored position.

In Example 2, the subject matter of Example 1 optionally includes the arm assembly comprising: a frame connected to the body, the linkage assembly pivotably connected to the frame.

In Example 3, the subject matter of Example 2 optionally includes wherein the linkage assembly, the hand, the linkage actuator, and the hand actuator are configured to nest within the frame when the linkage assembly is in the retracted position.

In Example 4, the subject matter of any one or more of Examples 2–3 optionally include the arm assembly comprising: a linkage drive train connected to the linkage assembly and the linkage actuator, the linkage drive train configured to transfer power from the linkage actuator to the linkage assembly to move the linkage assembly between the retracted position and the extended position.

In Example 5, the subject matter of Example 4 optionally includes the arm assembly comprising: a clutch connected to the linkage drive train and configured to disengage the linkage assembly from the linkage actuator when a force applied to the linkage assembly exceeds a threshold force.

In Example 6, the subject matter of any one or more of Examples 1–5 optionally include an encoder connected to the linkage assembly and configured to generate a signal based on a position of the linkage assembly relative to the body.

In Example 7, the subject matter of Example 6 optionally includes a controller connected to the body and in communication with the linkage actuator, the hand actuator, and the encoder, the controller configured to control the linkage actuator and the hand actuator based on the signal.

In Example 8, the subject matter of Example 7 optionally includes wherein the controller is configured to: detect an object on the floor surface; navigate the body of the mobile cleaning robot so that the hand will align with the object when the hand is in the extended position; operate the linkage actuator to move the arm assembly to the extended position; operate the hand actuator to move the fingers from the stored position to the open position; operate the hand actuator to move the fingers from the open position to the closed position to engage and grasp the object with the hand; operate the linkage actuator to move the arm assembly to lift the object off the floor surface; operate the drive system to move the body to a designated place location; and operate the hand actuator to drop the object in the designated place location.

In Example 9, the subject matter of any one or more of Examples 1–8 optionally include the hand comprising: a pair of worm gears connected respectively to the pair of fingers; and a drive worm connected to the hand actuator and engaged with the pair of worm gears, the hand actuator operable to drive the drive worm to move the fingers between the closed position, the open position, and the stored position.

In Example 10, the subject matter of any one or more of Examples 1–9 optionally include wherein the linkage assembly includes a four bar linkage.

Example 11 is a mobile cleaning robot comprising: a body; a drive system connected to the body and configured to move the body about a floor surface of an environment; and an arm assembly connected to the body, the arm assembly comprising: a frame connected to the body; a linkage assembly pivotably connected to the frame; a hand pivotably connected to the linkage assembly, the hand including a pair of fingers; a linkage actuator connected to the linkage assembly and operable to move the linkage assembly and the hand relative to the body between a retracted position and an extended position; and a hand actuator connected to the hand and operable to move the fingers between a closed position, an open position, and a stored position.

In Example 12, the subject matter of Example 11 optionally includes an encoder connected to the linkage assembly and configured to generate a signal based on a position of the linkage assembly relative to the body; and a controller connected to the body and in communication with the linkage actuator, the hand actuator, and the encoder, the controller configured to control the linkage actuator and the hand actuator based on the signal.

In Example 13, the subject matter of Example 12 optionally includes wherein the controller is configured to: detect an object on the floor surface; navigate the body of the mobile cleaning robot so that the hand will align with the object when the hand is in the extended position; operate the linkage actuator to move the arm assembly to the extended position; and operate the hand actuator to move the fingers from the stored position to the open position.

In Example 14, the subject matter of Example 13 optionally includes wherein the controller is configured to: operate the hand actuator to move the fingers from the open position to the closed position to engage and grasp the object with the hand; operate the linkage actuator to move the arm assembly to lift the object off the floor surface; operate the drive system to move the body to a designated place location; and operate the hand actuator to drop the object in the designated place location.

In Example 15, the subject matter of any one or more of Examples 11–14 optionally include wherein the linkage assembly, the hand, the linkage actuator, and the hand actuator are configured to nest within the frame when the linkage assembly is in the retracted position.

In Example 16, the subject matter of Example 15 optionally includes the arm assembly comprising: a linkage drive train connected to the linkage assembly and the linkage actuator, the linkage drive train configured to transfer power from the linkage actuator to the linkage assembly to move the linkage assembly between the retracted position and the extended position; and a clutch connected to the linkage drive train and configured to disengage the linkage assembly from the linkage actuator when a force applied to the linkage assembly exceeds a threshold force.

Example 17 is a mobile cleaning robot comprising: a body; a drive system connected to the body and configured to move the body about a floor surface of an environment; an arm assembly connected to the body, the arm assembly comprising: a linkage assembly pivotably connected to the body; a hand pivotably connected to the linkage assembly, the hand including a pair of fingers; a linkage actuator connected to the linkage assembly and operable to move the linkage assembly and the hand relative to the body between a retracted position and an extended position; and a hand actuator connected to the hand and operable to move the fingers between a closed position, an open position, and a stored position; and a controller connected to the body and in communication with the linkage actuator and the hand actuator to control the linkage actuator and the hand actuator.

In Example 18, the subject matter of Example 17 optionally includes an encoder connected to the linkage assembly and configured to generate a signal based on a position of the linkage assembly relative to the body, the controller configured to operate the hand actuator and the linkage actuator based on the signal.

In Example 19, the subject matter of Example 18 optionally includes wherein the controller is configured to: detect an object on the floor surface; navigate the body of the mobile cleaning robot so that the hand will align with the object when the hand is in the extended position; and operate the linkage actuator to move the arm assembly to the extended position.

In Example 20, the subject matter of Example 19 optionally includes wherein the controller is configured to: operate the hand actuator to move the fingers from the stored position to the open position; operate the hand actuator to move the fingers from the open position to the closed position to engage and grasp the object with the hand; operate the linkage actuator to move the arm assembly to lift the object off the floor surface; operate the drive system to move the body to a designated place location; and operate the hand actuator to drop the object in the designated place location.

In Example 21, the apparatuses or method of any one or any combination of Examples 1 – 20 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A mobile cleaning robot comprising:
a body;
a drive system connected to the body and configured to move the body about a floor surface of an environment; and
an arm assembly connected to the body, the arm assembly comprising:
a linkage assembly pivotably connected to the body;
a hand pivotably connected to the linkage assembly, the hand including a pair of fingers;
a linkage actuator connected to the linkage assembly and operable to move the linkage assembly and the hand relative to the body between a retracted position and an extended position; and
a hand actuator connected to the hand and operable to move the fingers between a closed position, an open position, and a stored position.

2. The mobile cleaning robot of claim 1, the arm assembly comprising:
a frame connected to the body, the linkage assembly pivotably connected to the frame.

3. The mobile cleaning robot of claim 2, wherein the linkage assembly, the hand, the linkage actuator, and the hand actuator are configured to nest within the frame when the linkage assembly is in the retracted position.

4. The mobile cleaning robot of claim 2, the arm assembly comprising:
a linkage drive train connected to the linkage assembly and the linkage actuator,
the linkage drive train configured to transfer power from the linkage
actuator to the linkage assembly to move the linkage assembly between the retracted position and the extended position.

5. The mobile cleaning robot of claim 4, the arm assembly comprising:
a clutch connected to the linkage drive train and configured to disengage the
linkage assembly from the linkage actuator when a force applied to the
linkage assembly exceeds a threshold force.

6. The mobile cleaning robot of claim 1, comprising:
an encoder connected to the linkage assembly and configured to generate a signal
based on a position of the linkage assembly relative to the body.

7. The mobile cleaning robot of claim 6, comprising:
a controller connected to the body and in communication with the linkage
actuator, the hand actuator, and the encoder, the controller configured to
control the linkage actuator and the hand actuator based on the signal.

8. The mobile cleaning robot of claim 7, wherein the controller is configured to:
detect an object on the floor surface;
navigate the body of the mobile cleaning robot so that the hand will align with the object when the hand is in the extended position;
operate the linkage actuator to move the arm assembly to the extended position;
operate the hand actuator to move the fingers from the stored position to the open position;
operate the hand actuator to move the fingers from the open position to the closed position to engage and grasp the object with the hand;
operate the linkage actuator to move the arm assembly to lift the object off the floor surface;
operate the drive system to move the body to a designated place location; and
operate the hand actuator to drop the object in the designated place location.

9. The mobile cleaning robot of claim 1, the hand comprising:
a pair of worm gears connected respectively to the pair of fingers; and
a drive worm connected to the hand actuator and engaged with the pair of worm gears, the hand actuator operable to drive the drive worm to move the fingers between the closed position, the open position, and the stored position.

10. The mobile cleaning robot of claim 1, wherein the linkage assembly includes a four bar linkage.

11. A mobile cleaning robot comprising:
a body;
a drive system connected to the body and configured to move the body about a floor surface of an environment; and
an arm assembly connected to the body, the arm assembly comprising:
a frame connected to the body;
a linkage assembly pivotably connected to the frame;
a hand pivotably connected to the linkage assembly, the hand including a pair of fingers;
a linkage actuator connected to the linkage assembly and operable to move
the linkage assembly and the hand relative to the body between a
retracted position and an extended position; and
a hand actuator connected to the hand and operable to move the fingers
between a closed position, an open position, and a stored position.

12. The mobile cleaning robot of claim 11, comprising:
an encoder connected to the linkage assembly and configured to generate a signal
based on a position of the linkage assembly relative to the body; and
a controller connected to the body and in communication with the linkage
actuator, the hand actuator, and the encoder, the controller configured to
control the linkage actuator and the hand actuator based on the signal.

13. The mobile cleaning robot of claim 12, wherein the controller is configured to:
detect an object on the floor surface;
navigate the body of the mobile cleaning robot so that the hand will align with the object when the hand is in the extended position;
operate the linkage actuator to move the arm assembly to the extended position; and
operate the hand actuator to move the fingers from the stored position to the open position.

14. The mobile cleaning robot of claim 13, wherein the controller is configured to:
operate the hand actuator to move the fingers from the open position to the closed position to engage and grasp the object with the hand;
operate the linkage actuator to move the arm assembly to lift the object off the floor surface;
operate the drive system to move the body to a designated place location; and
operate the hand actuator to drop the object in the designated place location.

15. The mobile cleaning robot of claim 11, wherein the linkage assembly, the hand, the linkage actuator, and the hand actuator are configured to nest within the frame when the linkage assembly is in the retracted position.

16. The mobile cleaning robot of claim 15, the arm assembly comprising:
a linkage drive train connected to the linkage assembly and the linkage actuator, the linkage drive train configured to transfer power from the linkage actuator to the linkage assembly to move the linkage assembly between the retracted position and the extended position; and
a clutch connected to the linkage drive train and configured to disengage the linkage assembly from the linkage actuator when a force applied to the linkage assembly exceeds a threshold force.

17. A mobile cleaning robot comprising:
a body;
a drive system connected to the body and configured to move the body about a floor surface of an environment;
an arm assembly connected to the body, the arm assembly comprising:
a linkage assembly pivotably connected to the body;
a hand pivotably connected to the linkage assembly, the hand including a pair of fingers;
a linkage actuator connected to the linkage assembly and operable to move the linkage assembly and the hand relative to the body between a retracted position and an extended position; and
a hand actuator connected to the hand and operable to move the fingers between a closed position, an open position, and a stored position; and
a controller connected to the body and in communication with the linkage actuator and the hand actuator to control the linkage actuator and the hand actuator.

18. The mobile cleaning robot of claim 17, comprising:
an encoder connected to the linkage assembly and configured to generate a signal based on a position of the linkage assembly relative to the body, the controller configured to operate the hand actuator and the linkage actuator based on the signal.

19. The mobile cleaning robot of claim 18, wherein the controller is configured to:
detect an object on the floor surface;
navigate the body of the mobile cleaning robot so that the hand will align with the object when the hand is in the extended position; and
operate the linkage actuator to move the arm assembly to the extended position.

20. The mobile cleaning robot of claim 19, wherein the controller is configured to:
operate the hand actuator to move the fingers from the stored position to the open position;
operate the hand actuator to move the fingers from the open position to the closed position to engage and grasp the object with the hand;
operate the linkage actuator to move the arm assembly to lift the object off the floor surface;
operate the drive system to move the body to a designated place location; and
operate the hand actuator to drop the object in the designated place location.
